(19) United States
(12) Patent Application Publication
(10) Pub. No.: US 2023/0027492 A1
(43) Pub. Date: Jan. 26, 2023

(54) DIFFUSER AND METHOD OF DIFFUSING

(71) Applicant: 2327100 ALBERTA INC., Wetaskiwin (CA)

(72) Inventor: Emmanuel L'ECUYER, Edmonton (CA)

(21) Appl. No.: 17/786,016

(22) PCT Filed: Dec. 16, 2020
(86) PCT No.: PCT/CA2020/051727

§ 371 Date: Jun. 16, 2022

Related U.S. Application Data
(60) Provisional application No. 62/950,995, filed on Dec. 20, 2019.

(51) Int. Cl. B05B 7/04; A01G 31/02; B05B 7/00

(52) U.S. Cl. CPC B05B 7/0433; A01G 31/02; B05B 7/0075

(57) ABSTRACT

The diffuser can have a body having a gas passage comprising a gas inlet connectable to a gas source for generating a stream of gas along the gas passage, and an outlet for exhausting the stream of gas in the form of a jet outside the body, a liquid chamber having a liquid inlet connectable to a liquid source, at least one liquid delivery conduit connecting the liquid chamber to the gas passage, the liquid delivery aperture having a cross-sectional width of less than 1 mm, preferably less than 0.5 mm, more preferably less than 0.1 mm, and even more preferably being a capillary conduit, the liquid delivery conduit extending transversally to the orientation of the stream of gas in the gas passage.

### BACKGROUND

Some growth techniques, such as aeroponics for instance, can involve growing plants in a controlled gaseous environment, and/or exposing the plants to water mist, rather than to humid soil.

It was known to spray water to foliage or roots of the plants in a manner to form a mist of droplets, using a liquid nozzle, and where fine droplets of the mist came into contact with a surface of the plant, such as foliage or roots of the plants.

Although known techniques were satisfactory to a certain extent, there remained room for improvement. For instance, it was known for some of said water droplets to miss the target, or otherwise collect into liquid pools. Such liquid pools can be undesired in growth environments as they can represent a breeding ground for contamination.

### SUMMARY

To limit the potential pooling of liquid, it can be desired to limit the size of the droplets. One can aim, for instance, in achieving droplets of less than 2 microns, preferably less than 1 micron, in the form of an aerosol. The droplet can further be mixed into a carrier gas. Even better, it can be preferred for the droplets to be so small, and for the percentage of humidity of the carrier gas to be controlled, in a manner that the droplets can easily evaporate into gaseous form and mix into the stream of gas before or as they are outputted in the form of a jet, thereby never having a chance of settling down and forming a pool over time.

In accordance with one aspect, there is provided a diffuser comprising a body having a gas passage having a gas inlet connectable to a gas source for generating a stream of gas along the gas passage, and an outlet for exhausting the stream of gas in the form of a jet outside the body, a liquid chamber having a liquid inlet connectable to a liquid source, at least one liquid delivery conduit connecting the liquid chamber to the gas passage, the liquid delivery conduit having a cross-sectional width of less than 1 mm, preferably less than 0.5 mm, more preferably less than 0.1 mm, and even more preferably being a capillary conduit, the liquid delivery aperture extending transversally to the orientation of the stream of gas in the gas passage.

In accordance with another aspect, there is provided a method of diffusing a substance, the method comprising circulating a stream of gas in a gas passage, and exposing said substance in liquid form to the gas passage via a liquid delivery aperture, the stream of gas drawing, via its velocity, liquid from the liquid delivery aperture, said liquid vaporizing and mixing into the stream of gas, and generating a jet of said stream of gas including a percentage of said vaporized liquid.

Many further features and combinations thereof concerning the present improvements will appear to those skilled in the art following a reading of the instant disclosure.

### DESCRIPTION OF THE FIGURES

In the figures,

FIG. 1 is a view of an example plant growth environment;

FIG. 2 is a cross-sectional view showing one example of a diffuser;

FIG. 3 is a cross-sectional view showing another example of a diffuser;

FIG. 4 is an exploded side view of yet another example of a diffuser, with FIG. 4A being an enlarged portion thereof;

FIG. 5 is an additional side view of the example diffuser of FIG. 4, with the inner tube assembled to the nozzle;

FIG. 6 is a longitudinal view of the example diffuser of FIG. 4, the diffuser being assembled and showing the nozzle end;

FIG. 7 is another view of the outer tube of the example diffuser of FIG. 4, showing the input end; and

FIG. 8 is another view of the nozzle of the example diffuser of FIG. 4, showing the input end.

### DETAILED DESCRIPTION

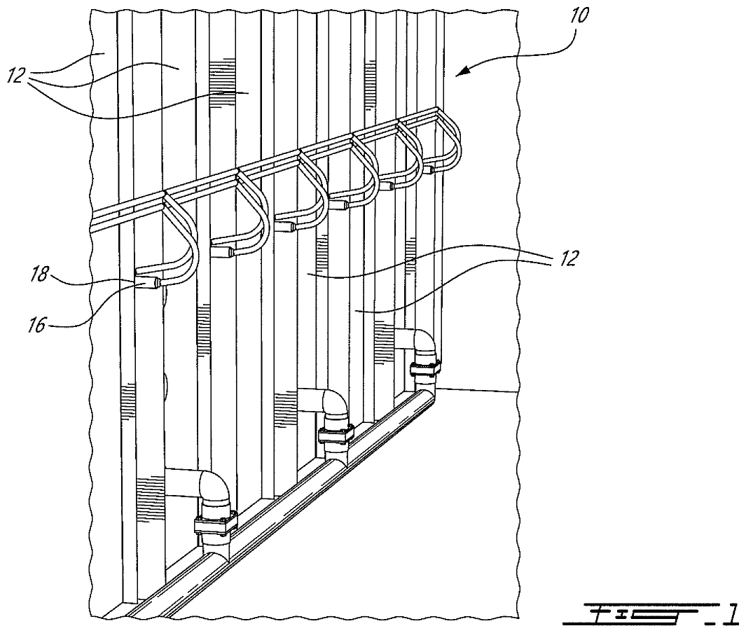

FIG. 1 shows an example of an example plant growth environment 10. In this example plant growth environment 10, at least a portion of the plant (e.g. roots, foliage, or the entire plant) is to be contained in an enclosed chamber 12 in which the environment is controlled. There are a number of such enclosed chambers 12 in this example, which are arrayed in an effort to optimize space usage. In one example, for instance, it can be desired to maintain the humidity level in the chambers 12 to a target value, within certain tolerances. Looking at one chamber 12, for instance, the humidity level can be monitored with one or more humidity sensor(s), and the humidity level can be raised, as water is absorbed by the plants, by providing jets of humid air via diffusers 16 having a nozzle penetrating 18 into the enclosed chambers 12. One can appreciate that in a context of an enclosed space as the one shown in FIG. 1, it can be particularly desirable to prevent any potential accumulation of water at the bottom of the enclosed chambers 12.

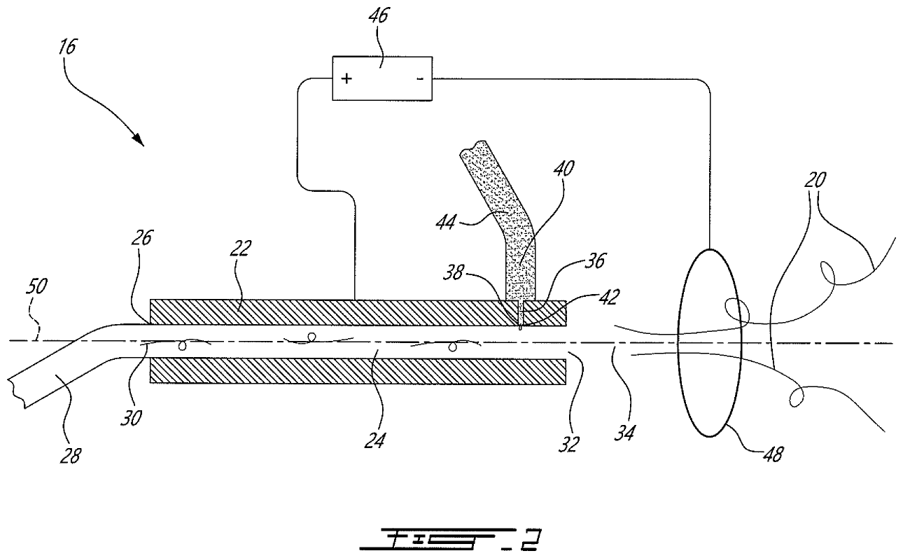

FIG. 2 is a cross-sectional schematic view showing an example of a diffuser 16 which can be used to spray a jet 20 of humid air. In this example, the diffuser 16 has a body 22 having a gas passage 24. The gas passage 24 is straight and cylindrical in this example, but it will be understood that it can have other shapes in alternate embodiments. The gas passage 24 has an inlet 26 connectable to a gas source, such as a compressed air hose 28 for example, and is configured for guiding a stream of gas 30 inside the body 22, along the gas stream passage 24. An outlet 32 of the diffuser 16 is open to the atmosphere/environment 34, where the stream of gas 30 is ultimately ejected in the form of a jet 20. A liquid delivery conduit 36 is provided with an outlet 38 fluidly connecting the liquid conduit 40 to the gas passage 24.

In this embodiment, the liquid delivery conduit 36 has a small cross-sectional area to limit the volume of liquid which can circulate across it and limit the size of droplets 42 which can be formed at its outlet 38 in a context of the strong stream of gas 30 circulating in the gas passage 24. The cross-sectional width of the liquid delivery conduit 36 can be less than 1 mm, less than 0.5 mm, or even less than 0.1 mm for instance. The liquid delivery conduit 36 can be a capillary conduit for instance. It was found that limiting the cross-sectional area of the liquid delivery conduit 36 was one factor which favored a good vaporization and mixing of the liquid droplets 42 into the gas stream 30 and gas stream jet 20, in turn limiting or even preventing any settling of droplets, in some embodiments.

Forming a small liquid delivery conduit 36 in a metal body can be achieved using specialized tooling. The achievable size can be limited by the smallest diameter of drills available. Laser machining may be a way of overcoming the limitations in drill sizes. In any event, a satisfactory size was achieved in one embodiment with a specialized diameter drill having a diameter significant less than 1 mm, such as between 0.1 mm and 1 mm for instance.

Other factors can contribute to the vaporization and mixing of the liquid droplets 42 into the jet 20, in some embodiments. Indeed, rather than forcing liquid into the gas stream 30 by pressure, it can be preferred to configure the fluid conduit(s) 40 in a manner that the water is drawn out of the liquid delivery conduit 36 by the velocity of the gas stream 30. This can involve providing a significantly greater pressure of compressed gas in the gas stream 30 than the pressure of water in the liquid delivery conduit 36, for instance. It was found that allowing the gas stream 30 to draw the water out provided a better vaporization and diffusion of the liquid than by forcing water droplets 42 into the gas stream 30. One way of configuring the fluid conduit(s) to achieve this functionality is by providing a liquid delivery conduit 36 which is oriented transversally to the orientation of the gas path 30. In the illustrated embodiment, for instance, the liquid delivery conduit 36 can be oriented to between 85° and 95° from the orientation of the gas path 24, for instance, and in one embodiment, the angle can be of 90° within fabrication tolerances. The transversal orientation appears to favor the shearing of micro-droplets as the liquid is being fed into the gas passage 24 via the liquid delivery conduit 36, and led to good results.

In one embodiment, and as described above, the liquid can be water. In another embodiment, the liquid can be a nutrient solution including plant growth nutrients dissolved in liquid water, for instance. The liquid can thus generally be referred to herein as a substance in liquid form 44.

During operation, a stream of gas 30 such as compressed air can be circulated in the gas passage 24, and the substance in liquid form 44 can be exposed to the gas passage 24 via the liquid delivery conduit 36. The stream of gas 30 can draw, via its velocity and dynamic fluid circulation effects, liquid from the liquid delivery aperture 36. The substance can vaporize and mix into the stream of gas 30, in a manner for the substance to be in gas/particulate form once it has reached the jet 20 of gas, or otherwise form liquid droplets so fine that they do not settle to the floor (not shown) under the diffuser 16.

Plant growth nutrients have been known to cause clogging when dissolved in water and circulated in small channels and conduits. In one embodiment, this has successfully been addressed by, once a satisfactory amount of liquid has been injected with the diffuser 16, releasing the liquid pressure while maintaining the gas pressure, in a manner to reverse the flow of liquid in the liquid delivery conduit 36, allowing gas into the liquid delivery conduit 36, and allowing the gas to ultimately clean the liquid delivery conduit 36 and empty it from the liquid. This can be done for a few seconds for instance. Accordingly, the water/nutrient solution source can be shut off while the air continues to blow for a short time cleaning the nozzle. The gas source can then also be cut-off after a certain amount of time has elapsed, for instance. In one embodiment, upon activating the diffuser 16, the gas source can be activated for a given amount of time (e.g. 2 seconds) before activating the liquid source, for instance.

In one embodiment, it can be preferred to electrically charge the jets. This can be achieved by providing a voltage source 46 forming a circuit by being connected, on the one hand, to the body of the diffuser 22, and on the other hand, to a ring 48 which can be provided coaxially with the axis of the gas path 50, in a manner to circumscribe the jet 20, at a certain distance from the gas outlet 32. The charge can be either positive or negative depending on the embodiment, and the voltage can be higher than 1000 volts, such as 8000 or 9000 DC volts for instance. In one embodiment, the voltage is DC. To this end, the body 22 of the diffuser 16 and the ring 48 can be made of materials being good electrical conductors, such as metals for instance, and they can be of the same or of different materials. Moreover, an insulator (not shown) can electrically insulate the ring 48 from the body 22 of the diffuser 16, forcing any electron exchange to be made via the fluid in the jet 20.

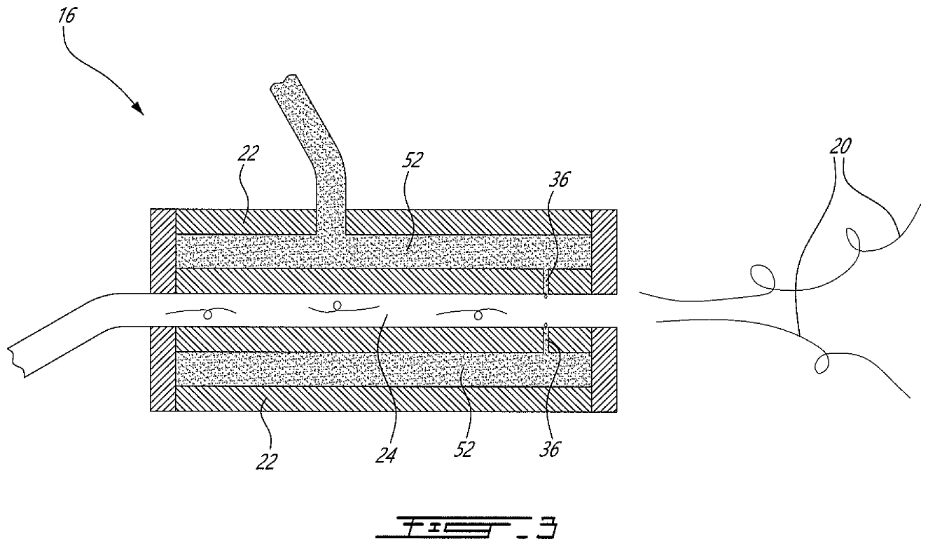

FIG. 3 shows an alternate embodiment where the body 22 of the diffuser 16 further comprises a liquid chamber 52 extending around the gas passage 24, and fluidly connected to the gas passage 24 via a plurality of liquid distribution conduits 36.

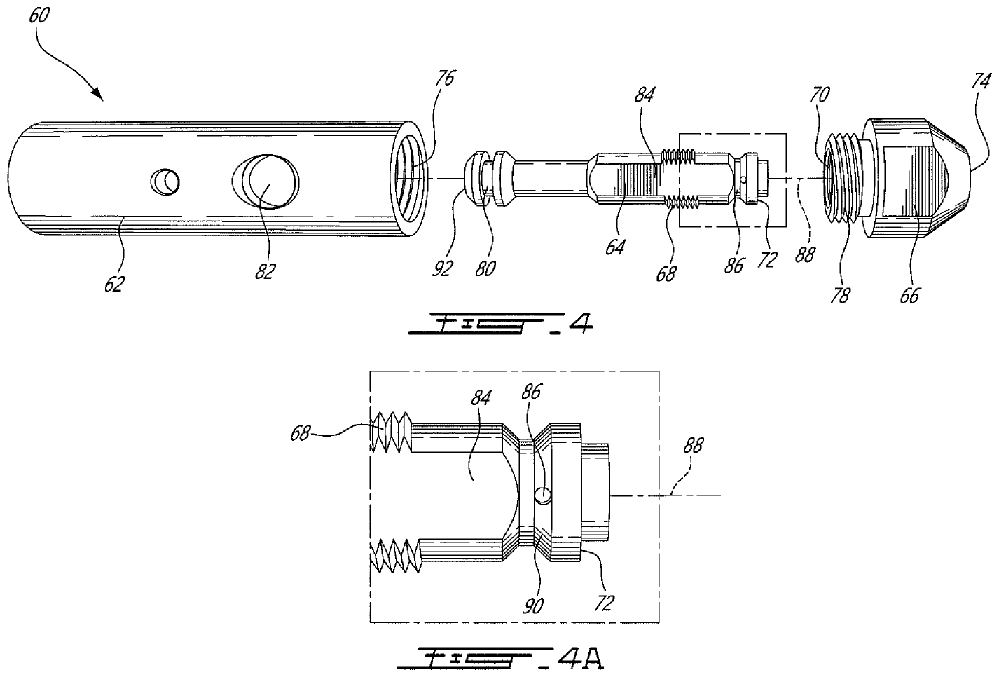

FIG. 4 shows an example embodiment of a diffuser 60 consisting of three different components 62, 64, 66, exploded. More specifically, the diffuser 60 includes an outer tube 62, an inner tube 64, and a nozzle 66. The components 62, 64, 66 are assembled by threadingly engaging an outer thread 68 of the inner tube 64 with an inner thread 70 of the nozzle 66 (perhaps best seen in FIG. 8) until the tip 72 of the inner tube 64 engages a receiving surface 74 (perhaps best seen in FIG. 8) of the nozzle 66 to seal it. Then, an inner thread 76 of the outer tube 62 is engaged on an outer thread 78 of the nozzle 66 until an O'ring (not shown, placed in gap 80) of the inner tube 64 engages and seals a corresponding aperture at an opposite end of the outer tube 62. The outer tube 62 has a liquid aperture 82 through its wall. All components are generally axissymetrical, with the notable exception of the apertures (such as the liquid aperture 82) in the wall of the outer tube 62, and a flat portion 84 of the inner tube 64. The flat portion 84 of the inner tube 64 coincides with the outer threads 68 of the inner tube 64, and allows circulation of liquid on each side of the inner tube 64, across the thread engagement. The liquid delivery conduit 86 is a straight hole oriented at 90 degrees from the axis 88 (oriented radially), and perforated in a face 90 of the inner tube 64 which slopes at 45 degrees, very close to the tip 72 and essentially at the longitudinal end of the liquid chamber formed between the outer tube 62 and the flat portions 84 of the inner tube 64. It was found that by operating the diffuser 60 of this example embodiment with a gas pressure, supplied via the gas inlet 92, significantly higher than a liquid pressure (such as 40 psi for the gas vs. 1-2 psi for the liquid for instance) as the sole source of humidity, the plants grew well, and no visible moisture accumulation was present on the ground.

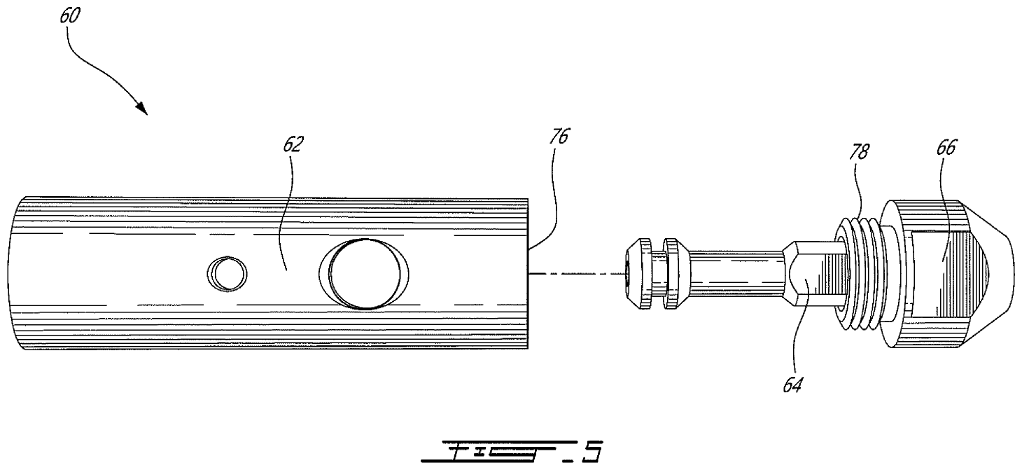

FIG. 5 shows another side view of the diffuser 60 of FIG. 4, where the inner tube 64 is assembled to the nozzle 66 via the engagement of the outer thread 68 of the inner tube 64 with the inner thread 70 of the nozzle 66. The inner tube 64 and nozzle 66 being assemblable with the outer tube 62 via the engagement of the outer thread 78 of the nozzle 66 with the inner thread 76 of the outer tube 62.

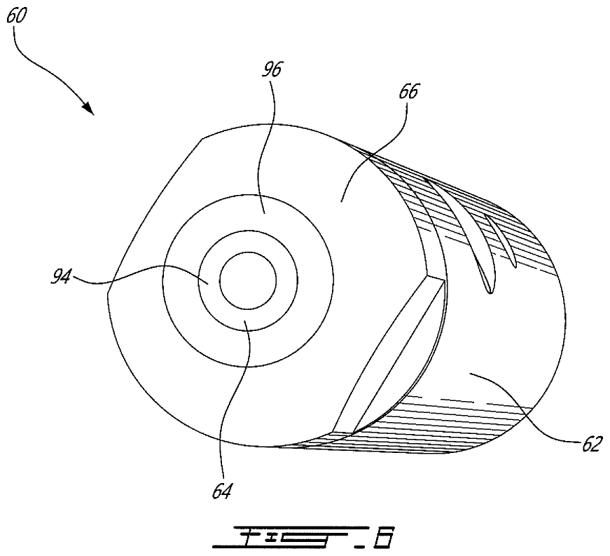

FIG. 6 is a longitudinal view of the assembled diffuser 60 of FIG. 4. The nozzle 66 is seen assembled with the inner tube 64 and with the outer tube 62. The tip 72 of the inner tube 64 is received against a receiving surface 74 (perhaps best seen in FIG. 8). In this embodiment, when the tip 72 abuts against the receiving surface 74, the end 94 of the inner tube 64 longitudinally corresponds to the end 96 of the nozzle 66.

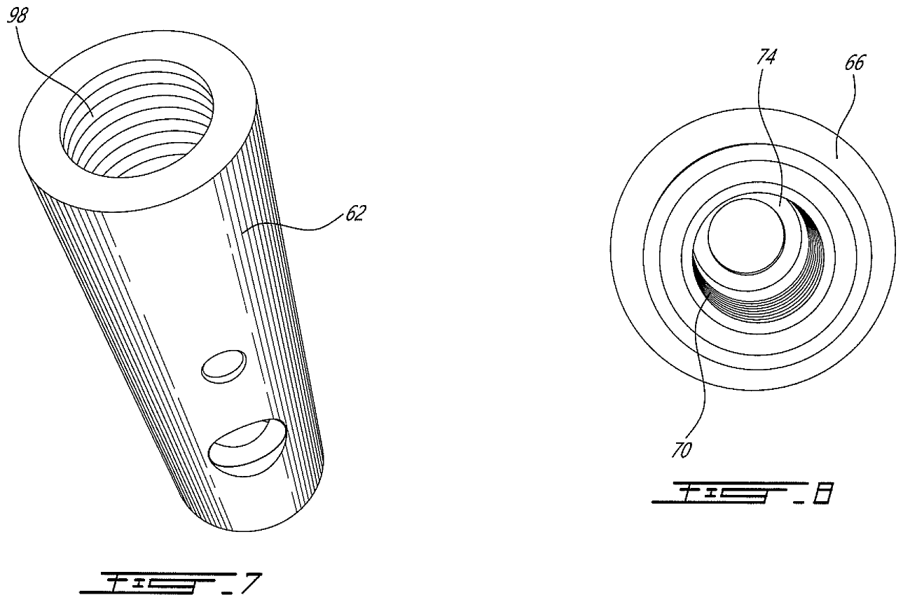

FIG. 7 is another view of a gas receiving end of the outer tube 62 of the diffuser 60 of FIG. 4. In this embodiment, similar to the inner thread 76 used to engage with the nozzle 66, the outer tube 62 also contains an inner thread 98 used to engage with a compressed air hose, for instance.

FIG. 8 is another view of the nozzle 66 of the diffuser 60 of FIG. 4. In this view, the receiving surface 74 configured to receive the tip 72 of the inner tube 64 (not shown) and an inner thread 70 configured to engage with the outer thread 68 of the inner tube 64 (not shown) can be seen.

A computer can be used to electronically control the gas source and the liquid source in a manner to operate the liquid source for a given duration, at given intervals, for instance, allowing the growing plant to be operated for extended periods of time without manual intervention.

As can be understood, the examples described above and illustrated are intended to be exemplary only. The scope is indicated by the appended claims.

What is claimed is:

1. A diffuser comprising a body having a gas passage having a gas inlet connectable to a gas source for generating a stream of gas along the gas passage, and an outlet for exhausting the stream of gas in the form of a jet outside the body, a liquid chamber having a liquid inlet connectable to a liquid source, at least one liquid delivery conduit connecting the liquid chamber to the gas passage, the liquid delivery aperture having a cross-sectional width of less than 1 mm, preferably less than 0.5 mm, more preferably less than 0.1 mm, and even more preferably being a capillary conduit, the liquid delivery conduit extending transversally to the orientation of the stream of gas in the gas passage.

2. The diffuser of claim 1 wherein the liquid chamber is formed of a good electrical conductor, further comprising a ring made of a good electrical conductor, said ring being coaxial with the gas passage, but offset from the body in a manner to surround the jet, and an electrical circuit including a voltage source having a first electrical conductor connecting the liquid chamber, and a second electrical conductor connecting the ring, and an electrical insulator between the ring and the liquid chamber.

3. The diffuser of claim 1 wherein the body is formed of an outer tube, an inner tube and a nozzle, the inner tube comprising the liquid delivery conduit, the inner tube being partially received within the outer tube and the nozzle when assembled, the liquid chamber being radially formed between the inner tube and the outer tube and between the inner tube and the nozzle, the gas passage defined along a length and within the inner tube.

4. The diffuser of claim 3 wherein the inner tube is engageable with the nozzle at a first longitudinal end and engageable with the outer tube at a second longitudinal end, the liquid chamber being formed between the first longitudinal end and second longitudinal end of the inner tube.

5. The diffuser of claim 4 wherein an O'ring seals the engagement of the inner tuber to the outer tube at the second longitudinal end.

6. The diffuser of claim 4 wherein the inner tube comprises a radially defined outer thread along a portion of the length of the inner tube and the nozzle comprising a radially defined inner thread configured to receive the outer thread of the inner tube, wherein the inner tube engages the nozzle at the first longitudinal end when the outer thread of the inner tube and the inner thread of the nozzle are engaged to one another.

7. The diffuser of claim 3 wherein the inner tube comprises a radially defined flat portion, circumferentially aligned with the liquid delivery conduit.

8. The diffuser of claim 7 comprising two of the flat portions and two of the liquid delivery conduits, each flat portion and liquid delivery conduit pair being placed circumferentially opposite to one another.

9. The diffuser of claim 3 wherein the liquid inlet is defined radially on the outer tube

10. The diffuser of claim 3 wherein nozzle is configured to be received within an enclosed chamber in which humidity levels are to be maintained.

11. The diffuser of claim 1 wherein a liquid received via the liquid inlet is water.

12. The diffuser of claim 1 where a liquid receive via the liquid inlet is a nutrient solution comprising a plant growth nutrient and water.

13. The diffuser of claim 1 where in the liquid chamber extends circumferentially around the gas passage.

14. A method of diffusing a substance, the method comprising circulating a stream of gas in a gas passage, and exposing said substance in liquid form to the gas passage via a liquid delivery aperture, the stream of gas drawing, via its velocity, liquid from the liquid delivery aperture, said liquid vaporizing and mixing into the stream of gas, and generating a jet of said stream of gas including a percentage of said vaporized liquid.

15. The method of claim 14 wherein said exposing said substance in liquid form includes maintaining a higher pressure of gas in the gas passage than a pressure of said substance in liquid form.

16. The method of claim 15, wherein said method further includes reversing the fluid flow orientation in the liquid delivery aperture for a given period of time after said vaporizing and mixing, including circulating gas into the liquid delivery aperture.

17. The method of claim 14 including, in sequence:
a first phase of operation during which gas pressure is provided into the gas passage;
a second phase of operation during which the gas pressure is maintained, and a liquid pressure is further provided in the liquid delivery aperture;
a third phase of operation during which the liquid pressure is released;
and wherein the gas pressure is released subsequently to the third phase.

18. The method of claim 17 wherein said exposing said substance in liquid form includes limiting the cross-sectional area of the exposed liquid to less than 1 square millimetre.

19. The method of claim 18 wherein the cross-sectional area of the exposed liquid is limited to less than 0.1 square millimetre, preferably less than 0.01 square millimetre, more preferably less than 0.001 square millimetre.

20. The method of claim 14 including releasing the jet in an enclosed plant cultivation area.
